(19) United States
(12) Patent Application Publication
(10) Pub. No.: US 2015/0008722 A1
(43) Pub. Date: Jan. 8, 2015

(54) Wheel Spacer

(71) Applicant: Cory Bride, Wysox, PA (US)

(72) Inventor: Cory Bride, Wysox, PA (US)

(21) Appl. No.: 13/933,256

(22) Filed: Jul. 2, 2013

(51) Int. Cl. B60B 11/06

(52) U.S. Cl. CPC B60B 11/06
USPC 301/13.2

(57) ABSTRACT

A wheel spacer for dual wheels that allows for larger tires to be mounted to the dual-wheel assembly of a motor vehicle. The wheel spacer has a main body surrounding a central aperture. A plurality of attachment apertures are located along the main body and a plurality of threaded bolts extent from the main body's front surface.

### CROSS-REFERENCE TO RELATED APPLICATIONS

Not Applicable.

### STATEMENT REGARDING FEDERALLY SPONSORED RESEARCH

Not Applicable.

### BACKGROUND

1. Field of Invention

The present invention relates to wheel spacers mounted to a motor vehicle. More particularly, the present invention relates to a wheel spacer mounted between dual rear wheels of a motor vehicle.

2. Description of Related Art

Light trucks or light duty trucks are commonly used in industrial and commercial industries to transport property and people to and from job sites. In some such industries, such as the drilling industry for example, the job sites are inaccessible via improved roadways. Accordingly, field workers use light duty trucks and similar vehicles to travel “off road” and access such job sites. Uneven grade, ditches, loose or soft soil (i.e., mud), and obstacles such as rock and debris make traveling in such manner difficult.

To improve the traction of light duty trucks and allow them to better navigate such environments, dual rear wheels are mounted to the truck's rear axle. However, sometimes users of such trucks want to mount larger tires on the rear axle, but the construction of the hub and rim assembly do not allow enough room for larger tires to be mounted side-by-side. Accordingly, there is a need for an apparatus that will allow for larger tires to be easily and conveniently mounted to existing dual-wheel mounting assemblies.

### SUMMARY

The primary objective of the present invention is to provide a wheel spacer that will allow larger tires to be mounted to existing dual-wheel mounting assemblies. The wheel spacer comprises a main body surrounding a central aperture. The main body includes a plurality of attachment apertures. Threaded bolts transversely extend from the face of the main body. The threaded bolts of the main body are positioned to enter corresponding apertures of the hub of the outer wheel. The attachment apertures are positioned to receive fasteners threaded through and connected to the hub of the inner wheel.

### BRIEF DESCRIPTION OF THE DRAWINGS

FIG. 1 is a perspective view of a wheel spacer consistent with the present invention.

FIG. 2 is an exploded view of a wheel spacer consistent with the present invention engaging a dual wheel assembly.

FIG. 3 is a side view of a wheel spacer and dual-wheel assembly consistent with the present invention.

### DETAILED DESCRIPTION

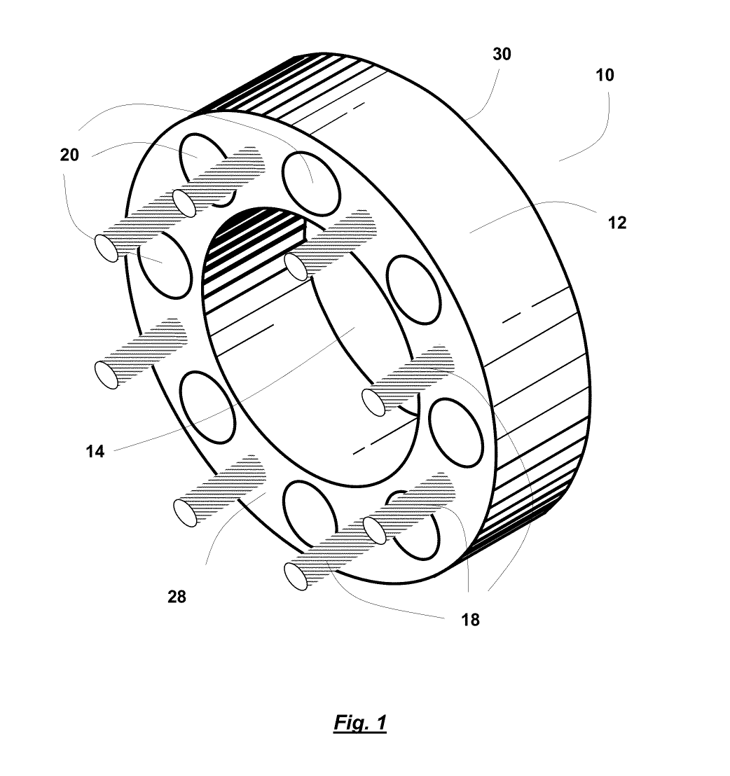

Referring to FIG. 1, a wheel spacer 10 for a dual wheel is provided and comprises a main body 12 surrounding a central aperture 14. The main body 12 has a front surface 28 and a back surface 30. The main body 12 is comprised of a plurality of alternating threaded bolts 18 and attachment apertures 20. The threaded bolts 18 extend generally from the main body's 12 front surface 28. The wheel spacer 10 is preferably constructed of galvanized steel, but any metallic material capable of supporting the load and stress of a dual-wheel assembly may be used.

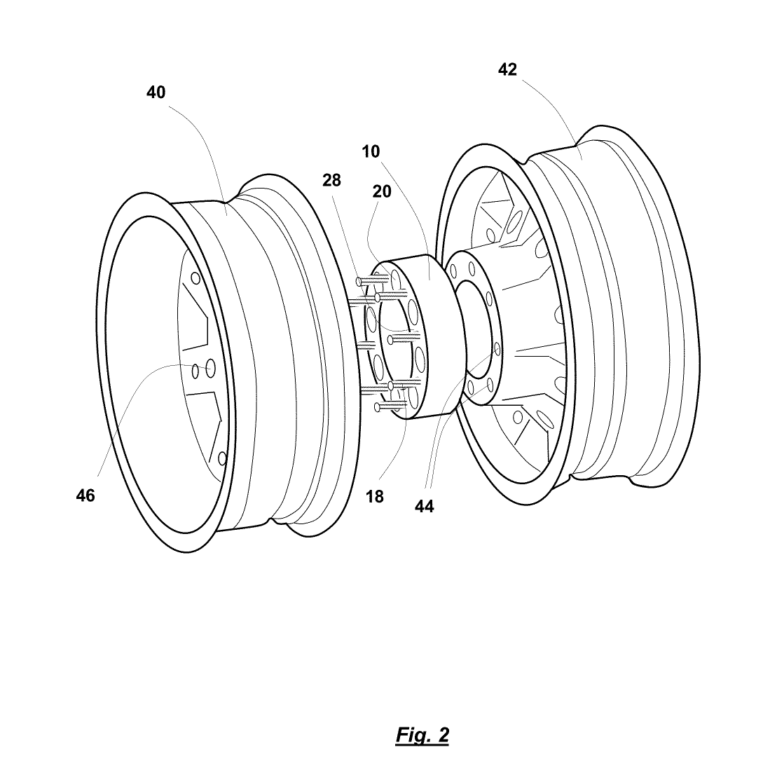

Referring to FIG. 2, when mounted to a motor vehicle, the wheel spacer 10 is positioned between the outer wheel 40 and the inner wheel 42. Attachment apertures 44 of the inner wheel 42 are used to the mount the inner wheel 42 to the wheel studs (not shown in the figures) of the vehicle. The attachment apertures 20 of the wheel spacer 10 are then guided on to the exposed ends of the wheel studs, and the wheel spacer and inner wheel 42 are attached to the wheel studs with nuts that are tightened to the front surface 28 of the wheel spacer 10.

The threaded bolts 18 of the wheel spacer 10 engage attachment apertures of the outer wheel 40 (not shown in the figures) and the wheel spacer 10 is attached to the outer wheel 40 via lug nuts (not shown in the figures) that are threaded onto the exposed ends of the threaded bolts 18 once they are pushed through the attachment apertures 46 of the outer wheel 40.

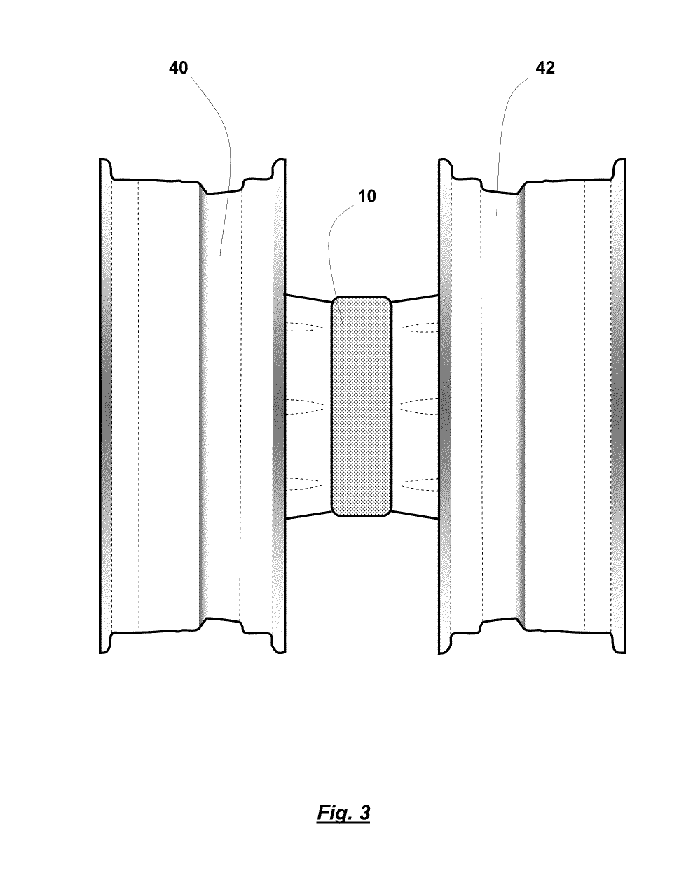

As shown in FIG. 3, when the wheel spacer 10 and inner wheel 42 are attached to the wheel studs of the vehicle and the outer wheel 40 is attached to the threaded bolts 18 of the wheel spacer 10, the wheel spacer 10 extends the distance between the outer wheel 40 and inner wheel 42, thereby allowing larger tires to be affixed to the outer 40 and inner wheels 42 of the dual-wheel assembly.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A wheel spacer for dual wheels comprising:
(a) a main body;
(b) a central aperture;
(c) a plurality of threaded bolts; and
(d) a plurality of attachment apertures.
